(19) United States
(12) Patent Application Publication
(10) Pub. No.: US 2024/0256977 A1
(43) Pub. Date: Aug. 1, 2024

(54) IMAGE SETTING DETERMINATION AND ASSOCIATED MACHINE LEARNING IN INFRARED IMAGING SYSTEMS AND METHODS

(71) Applicant: FLIR Systems AB, Täby (SE)

(72) Inventors: Lukas Segelmark, Soln (SE); Tintin Razavian, Täby (SE); Johan Johansson, Täby (SE)

(21) Appl. No.: 18/611,639

(22) Filed: Mar. 20, 2024

Related U.S. Application Data
(63) Continuation of application No. PCT/US2022/044944, filed on Sep. 27, 2022.
(60) Provisional application No. 63/249,545, filed on Sep. 28, 2021.

(51) Int. Cl. G06N 20/00

(52) U.S. Cl. CPC G06N 20/00

(57) ABSTRACT

Techniques for facilitating image setting determination and associated machine learning in infrared imaging systems and methods are provided. In one example, an infrared imaging system includes an infrared imager, a logic device, and an output/feedback device. The infrared imager is configured to capture image data associated with a scene. The logic device is configured to determine, using a machine learning model, an image setting based on the image data. The output/feedback device is configured to provide an indication of the image setting. The output/feedback device is further configured to receive user input associated with the image setting. The output/feedback device is further configured to determine, for use in training the machine learning model, a training dataset based on the user input and the image setting. Related devices and methods are also provided.

### CROSS-REFERENCE TO RELATED APPLICATIONS

This application is a continuation of International Patent Application No. PCT/US2022/044944 filed Sep. 27, 2022 and entitled “IMAGE SETTING DETERMINATION AND ASSOCIATED MACHINE LEARNING IN INFRATED IMAGING SYSTEMS AND METHODS,” which claims the benefit of U.S. Patent Application No. 63/249,545 filed Sep. 28, 2021 and entitled “IMAGE SETTING DETERMINATION AND ASSOCIATED MACHINE LEARNING IN INFRARED IMAGING SYSTEMS AND METHODS,” all of which are incorporated herein by reference in their entirety.

### TECHNICAL FIELD

One or more embodiments relate generally to imaging and more particularly, for example, to image setting determination and associated machine learning in infrared imaging systems and methods.

### BACKGROUND

Imaging systems may include an array of detectors arranged in rows and columns, with each detector functioning as a pixel to produce a portion of a two-dimensional image. For example, an individual detector of the array of detectors captures an associated pixel value. There are a wide variety of image detectors, such as visible-light image detectors, infrared image detectors, or other types of image detectors that may be provided in an image detector array for capturing an image. As an example, a plurality of sensors may be provided in an image detector array to detect electromagnetic (EM) radiation at desired wavelengths. In some cases, such as for infrared imaging, readout of image data captured by the detectors may be performed in a time-multiplexed manner by a readout integrated circuit (ROIC). The image data that is read out may be communicated to other circuitry, such as for processing, storage, and/or display. In some cases, a combination of a detector array and an ROIC may be referred to as a focal plane array (FPA). Advances in process technology for FPAs and image processing have led to increased capabilities and sophistication of resulting imaging systems.

### SUMMARY

In one or more embodiments, a method includes receiving image data associated with a scene. The method further includes determining, using a machine learning model, an image setting based on the image data. The method further includes providing an indication of the image setting. The method further includes receiving user input associated with the image setting. The method further includes determining, for use in training the machine learning model, a training dataset based on the user input and the image setting.

In one or more embodiments, an infrared imaging system includes an infrared imager, a logic device, and an output/feedback device. The infrared imager is configured to capture image data associated with a scene. The logic device is configured to determine, using a machine learning model, an image setting based on the image data. The output/feedback device is configured to provide an indication of the image setting. The output/feedback device is further configured to receive user input associated with the image setting. The output/feedback device is further configured to determine, for use in training the machine learning model, a training dataset based on the user input and the image setting.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an example imaging system in accordance with one or more embodiments of the present disclosure.

FIG. 2 illustrates a block diagram of an example image sensor assembly in accordance with one or more embodiments of the present disclosure.

FIG. 3 illustrates a block diagram of a neural network in accordance with one or more embodiments of the present disclosure.

FIG. 4 illustrates an example system for facilitating image setting determination and machine learning for infrared imaging in accordance with one or more embodiments of the present disclosure.

FIG. 5 illustrates a flow diagram of an example process for facilitating image setting determination and machine learning for infrared imaging in accordance with one or more embodiments of the present disclosure.

FIG. 6 illustrates a flow diagram associated with automatic measurement alignment in accordance with one or more embodiments of the present disclosure.

FIG. 7 illustrates a graphical user interface for displaying image settings and receiving user input in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Various techniques are provided to facilitate image setting determination and associated machine learning in infrared imaging systems and methods. An infrared imaging system (e.g., a thermal camera) may be used to capture infrared image data associated with a scene using an image sensor device (e.g., a detector array of an FPA). The image sensor device includes detectors (e.g., also referred to as detector pixels, detector elements, or simply pixels). Each detector pixel may detect incident EM radiation and generate infrared image data indicative of the detected EM radiation of the scene. In some embodiments, the image sensor array is used to detect infrared radiation (e.g., thermal infrared radiation). For pixels of an infrared image (e.g., thermal infrared image), each output value of a pixel may be represented/provided as and/or correspond to a temperature, digital count value, percentage of a full temperature range, or generally any value that can be mapped to the temperature. For example, a digital count value of 13,000 output by a pixel may represent a temperature of 160° C. As such, the captured infrared image data may indicate or may be used to determine a temperature of objects, persons, and/or other features/aspects in the scene. In some cases, the image sensor device may include detectors to detect EM radiation in other wavebands, such as visible-light wavebands.

In some embodiments, the infrared imaging system may determine/set (e.g., automatically/autonomously determine/set) image settings using one or more trained machine learning models. The machine learning model(s) may be a neural network (e.g., a convolutional neural network, transformer-type neural network, and/or other neural network), a decision tree-based machine model, and/or other machine learning models. In some cases, the type of machine learning model trained and used may be dependent on the type of data. Image settings may include, by way of non-limiting examples, measurement functions (e.g., spots, boxes, lines, circles, polygons, polylines) such as temperature measurement functions, image parameters (e.g., emissivity, reflected temperature, distance, atmospheric temperature, external optics temperature, external optics transmissivity), palettes (e.g., color palette, grayscale palette), temperature alarms (e.g., type of alarm, threshold levels), fusion modes (e.g., thermal/visual only, blending, fusion, picture-in-picture (PIP)), fusion settings (e.g., alignment, PIP placement), level and span/gain control, zoom/cropping, equipment type classifications, fault classifications, recommended actions, text annotations/notes, and/or others.

In some aspects, in addition to infrared data, the infrared imaging system may use other sensor data from one or more sensor devices as input into the machine learning model(s) (e.g., pre-trained neural network(s)). By way of non-limiting examples, a sensor device may include a visible-light camera, a temperature sensor, a distance measurement device (e.g., laser measurement, time of flight camera), a geoposition device (e.g., global positioning system (GPS) or similar device), and/or others. As a non-limiting example, image setting determination and associated machine learning may be used in industrial environments. As an example, in industrial environments such as manufacturing facilities or other similar locations, image data of various assets such as machines, electronics, and/or other devices may be captured and the image data inspected/analyzed.

A user of the infrared imaging system may provide user input (e.g., user feedback) to the image settings. Indications associated with the image settings determined by the infrared imaging system (e.g., using the machine learning model(s)) may be displayed to facilitate review and feedback from the user. The indications may be visual indications (e.g., text, numeric values, icons, labels, etc.) and/or audible indications (e.g., sounds). As non-limiting examples, indications may include a visualization of captured image data itself (e.g., an image generated based on the captured image data and the determined image settings); explicit values of the image settings themselves (e.g., emissivity value, reflected temperature value, distance measurement, etc.); overlays indicative of a location (e.g., marker/label overlaid on an image to provide a positional indication of a measurement, reading, or object in an image); an assessment (e.g., fault assessment), a classification (e.g., object-type classification, equipment classification), or a calculation resulting from the image settings (e.g., temperature calculation of a circular region in an image); overlays indicative of an assessment, a classification, or a calculation; combinations thereof; and/or others. Indications such as the explicit values, overlays, assessments, and so forth may be presented using alphabetical and/or numerical characters, pictorial features (e.g., icons, markers, arrows), and/or others. In some cases, certain image settings, such as alarms, may also be amenable to audible indications. For example, to alert the user in equipment inspection applications, a sound may be emitted when any portion of a scene (e.g., an object detected in the scene) exhibits a potential fault (e.g., temperature above a safety threshold, shape determined to be that of a broken wire) and/or an appropriate palette(s) (e.g., palette having vibrant colors at higher temperatures) may be applied to image data at and around the potential fault and/or areas away from the potential fault. In one example case, one or more color palettes may be used for problem areas and one or more grayscale palettes may be used everywhere else.

The image settings determined by the infrared imaging system may be referred to as predicted image settings or predicted correct image settings and corresponding image settings provided by the user may be referred to as target image settings. Training datasets may be formed of the image data, the image settings, the user input, and/or other associated data (e.g., geoposition information, atmospheric temperature information). The training datasets may be used to train (e.g., adjust/update) the machine learning model(s) used to generate the predicted image settings. In some cases, alternatively or in addition, the training datasets may include loss values determined using loss functions. For a given image setting, the infrared imaging system may define and utilize an appropriate loss function indicative of a difference between the predicted image setting and the target image setting. Different image settings may be associated with different loss functions.

In some cases, the indications of the image settings may be adjusted in response to the user input. As an example, an indication may be an image presented to the user, where the image may change (e.g., continuously, periodically, upon user confirmation) in response to changes the user makes to the emissivity and reflected temperature values predicted by the machine learning model(s). As another example, indications may include a marker overlaid on the image to identify a pixel in the image and a temperature reading associated with the pixel. A location of the marker and the temperature reading may change in response to movement of the marker by the user. The temperature reading is updated (e.g., continuously, periodically, upon user confirmation) to reflect a current location of the marker.

In some embodiments, for any given trained machine learning model, the trained machine learning model used to determine one or more of the image settings may be further trained (e.g., retrained, updated, adjusted) through iterative interactions between the predictions by the machine learning model on sensing data, adjustments/corrections from the user, and/or data derived from the predictions and user adjustments/corrections (e.g., the loss functions). The sensing data may generally refer to any data provided as input to the machine training model and thus may include thermal image data, visible-light image data, image data formed by combining image data from multiple wavebands, temperature measurements (e.g., imager's internal component temperature, atmospheric temperature), humidity measurements, geoposition data, distance measurements, and/or others. The further trained machine learning model may be used to determine image settings based on new input data (e.g., subsequently received sensing data). The iterative interactions and continued training of any given machine learning model may allow the machine learning model to predict more accurate image settings. It is noted that an accuracy of any image setting may be dependent on the user, the application, and/or other criteria. Certain image settings may be objective (e.g., parameters such as emissivity, reflected temperature, distance, atmospheric temperature, etc.) whereas others may be more user-dependent and/or application-dependent (e.g., notes/annotations, fault severity assessment, measurement locations and associated functions, etc.).

As an example, a user (e.g., thermographer) of the infrared imaging system may capture image data using the infrared imaging system and may be presented with a resulting image and predicted image settings. The user may provide manual input on the infrared imaging system, for example by editing one or more of the predicted image settings. The infrared imaging system may take a difference between the predicted image settings made by the infrared imaging system and the target image settings from the user as input into a loss function for machine learning model training (e.g., using back propagation and gradient descent). For example, one of the image settings may be a predicted temperature measurement location. An edit to this predicted temperature measurement location may be a manual user input to move the predicted measurement location to another location (e.g., referred to as a target temperature measurement location). A difference between the predicted temperature measurement location and the target temperature measurement location may be provided as input into a loss function for machine learning model training. In some cases, a weight (e.g., an importance) the infrared imaging system places on a particular user input may be based on a relevance to a machine learning model (e.g., the same user input for a given image setting may have a different weight applied for a different machine learning model) and/or the user themselves in relation to a particular application. As an example, the user's level of training and/or area of expertise may be factored into the weight.

As another example, when the user is viewing a thermal infrared image of a scene and/or temperature measurements of the scene, an accuracy of any temperature data represented in the thermal image and/or the temperature measurements may depend on an accuracy of image settings such as emissivity, reflected temperature values, and so forth. In addition, image settings that indicate consistent measurement locations and consistent measurement functions may provide comparable readings, such as image settings to consistently locate and calculate temperature readings of an object that repeatedly appears in a sequence of images of the scene captured at different times. These image settings as well as other image settings provided above may be adjusted as appropriate otherwise the image and/or the temperature measurements of the scene may not accurately represent actual temperature information about the scene.

Utilization of predicted image settings and associated user input (or lack thereof) may allow for updated machine learning models that can be used to make better predicted image settings. Furthermore, by automating the setting/predicting of image settings while iteratively training the machine learning models and leveraging user input from one or more users (e.g., of varying levels of expertise), a workflow applicable to various applications (e.g., equipment inspection, surveillance, object detection, etc.) may be created that reduces/minimizes errors in predicted image settings and produces more accurate imaging. The updated machine learning models may be deployed in a single camera (e.g., the infrared imaging system) or multiple cameras (e.g., cameras of the same make and model or otherwise having nominally similar performance characteristics). In some embodiments, image settings determined by multiple cameras can be used together with user input corresponding to these image settings provided by the user and/or other users using the same camera(s) and/or different camera(s) to train and update machine learning models.

Although various embodiments for image setting determination and machine learning are described primarily with respect to infrared imaging, methods and systems disclosed herein may be utilized in conjunction with devices and systems such as infrared imaging systems, imaging systems having visible-light and infrared imaging capability, short-wave infrared (SWIR) imaging systems, light detection and ranging (LIDAR) imaging systems, radar detection and ranging (RADAR) imaging systems, millimeter wavelength (MMW) imaging systems, ultrasonic imaging systems, X-ray imaging systems, microscope systems, mobile digital cameras, video surveillance systems, video processing systems, or other systems or devices that may need to obtain image data in one or multiple portions of the EM spectrum.

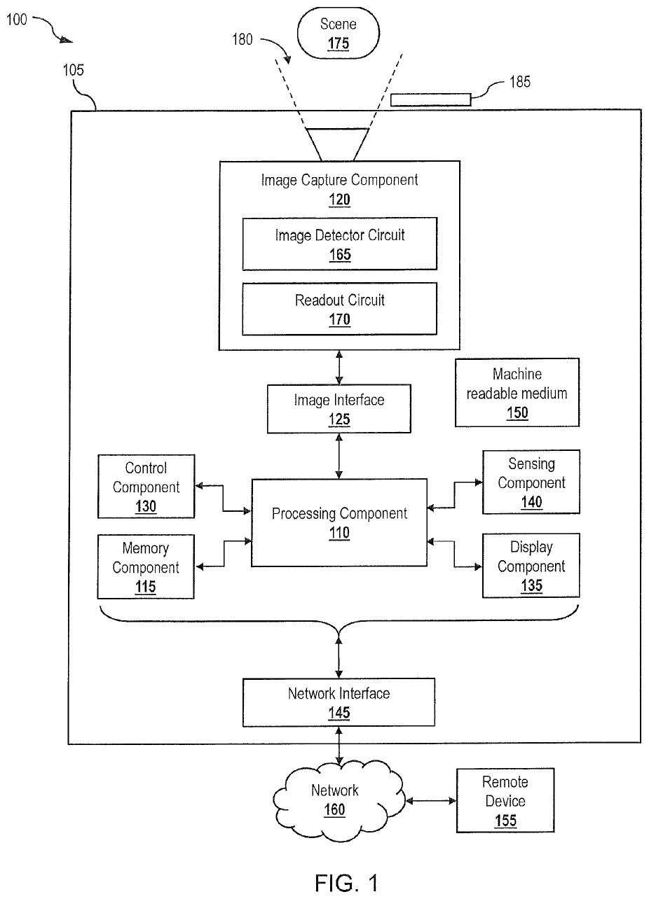

Referring now to the drawings, FIG. 1 illustrates a block diagram of an example imaging system 100 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth hercin. Additional components, different components, and/or fewer components may be provided.

The imaging system 100 may be utilized for capturing and processing images in accordance with an embodiment of the disclosure. The imaging system 100 may represent any type of imaging system that detects one or more ranges (e.g., wavebands) of EM radiation and provides representative data (e.g., one or more still image frames or video image frames). The imaging system 100 may include an imaging device 105. By way of non-limiting examples, the imaging device 105 may be, may include, or may be a part of an infrared camera (e.g., a thermal camera), a visible-light camera, a tablet computer, a laptop, a personal digital assistant (PDA), a mobile device, a desktop computer, or other electronic device. The imaging device 105 may include a housing (e.g., a camera body) that at least partially encloses components of the imaging device 105, such as to facilitate compactness and protection of the imaging device 105. For example, the solid box labeled 105 in FIG. 1 may represent a housing of the imaging device 105. The housing may contain more, fewer, and/or different components of the imaging device 105 than those depicted within the solid box in FIG. 1. In an embodiment, the imaging system 100 may include a portable device. The portable device may be handheld and/or may be incorporated, for example, into a vehicle or a non-mobile installation requiring images to be stored and/or displayed. The vehicle may be a land-based vehicle (e.g., automobile, truck), a naval-based vehicle, an aerial vehicle (e.g., unmanned aerial vehicle (UAV)), a space vehicle, or generally any type of vehicle that may incorporate (e.g., installed within, mounted thereon, etc.) the imaging system 100. In another example, the imaging system 100 may be coupled to various types of fixed locations (e.g., a home security mount, a campsite or outdoors mount, or other location) via one or more types of mounts.

The imaging device 105 includes, according to one implementation, a logic device 110, a memory component 115, an image capture component 120 (e.g., an imager, an image sensor device), an image interface 125, a control component 130, a display component 135, a sensing component 140, and/or a network interface 145. The logic device 110, according to various embodiments, includes one or more of a processor, a microprocessor, a central processing unit (CPU), a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, neural processing unit (NPU), or other logic device, one or more memories for storing executable instructions (e.g., software, firmware, or other instructions), and/or or any other appropriate combination of processing device and/or memory to execute instructions to perform any of the various operations described herein. The logic device 110 may be configured, by hardwiring, executing software instructions, or a combination of both, to perform various operations discussed herein for embodiments of the disclosure. The logic device 110 may be configured to interface and communicate with the various other components (e.g., 115, 120, 125, 130, 135, 140, 145, etc.) of the imaging system 100 to perform such operations. For example, the logic device 110 may be configured to process captured image data received from the imaging capture component 120, store the image data in the memory component 115, and/or retrieve stored image data from the memory component 115. In one aspect, the logic device 110 may be configured to perform various system control operations (e.g., to control communications and operations of various components of the imaging system 100) and other image processing operations (e.g., video analytics, data conversion, data transformation, data compression, etc.).

The memory component 115 includes, in one embodiment, one or more memory devices configured to store data and information, including infrared image data and information. The memory component 115 may include one or more various types of memory devices including volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the logic device 110 may be configured to execute software instructions stored in the memory component 115 so as to perform method and process steps and/or operations. The logic device 110 and/or the image interface 125 may be configured to store in the memory component 115 images or digital image data captured by the image capture component 120. In some embodiments, the memory component 115 may store various infrared images, visible-light images, combined images (e.g., infrared images blended with visible-light images), image settings, user input, sensor data, and/or other data.

In some embodiments, a separate machine-readable medium 150 (e.g., a memory, such as a hard drive, a compact disk, a digital video disk, or a flash memory) may store the software instructions and/or configuration data which can be executed or accessed by a computer (e.g., a logic device or processor-based system) to perform various methods and operations, such as methods and operations associated with processing image data. In one aspect, the machine-readable medium 150 may be portable and/or located separate from the imaging device 105, with the stored software instructions and/or data provided to the imaging device 105 by coupling the machine-readable medium 150 to the imaging device 105 and/or by the imaging device 105 downloading (e.g., via a wired link and/or a wireless link) from the machine-readable medium 150. It should be appreciated that various modules may be integrated in software and/or hardware as part of the logic device 110, with code (e.g., software or configuration data) for the modules stored, for example, in the memory component 115.

The imaging device 105 may be a video and/or still camera to capture and process images and/or videos of a scene 175. In this regard, the image capture component 120 of the imaging device 105 may be configured to capture images (e.g., still and/or video images) of the scene 175 in a particular spectrum or modality. The image capture component 120 includes an image detector circuit 165 (e.g., a visible-light detector circuit, a thermal infrared detector circuit) and a readout circuit 170 (e.g., an ROIC). For example, the image capture component 120 may include an IR imaging sensor (e.g., IR imaging sensor array) configured to detect IR radiation in the near, middle, and/or far IR spectrum and provide IR images (e.g., IR image data or signal) representative of the IR radiation from the scene 175. For example, the image detector circuit 165 may capture (e.g., detect, sense) IR radiation with wavelengths in the range from around 700 nm to around 2 mm, or portion thereof. For example, in some aspects, the image detector circuit 165 may be sensitive to (e.g., better detect) SWIR radiation, mid-wave IR (MWIR) radiation (e.g., EM radiation with wavelength of 2 μm to 5 μm), and/or long-wave IR (LWIR) radiation (e.g., EM radiation with wavelength of 7 μm to 14 μm), or any desired IR wavelengths (e.g., generally in the 0.7 μm to 14 μm range). In other aspects, the image detector circuit 165 may capture radiation from one or more other wavebands of the EM spectrum, such as visible light, ultraviolet light, and so forth.

The image detector circuit 165 may capture image data (e.g., infrared image data) associated with the scene 175. To capture a detector output image, the image detector circuit 165 may detect image data of the scene 175 (e.g., in the form of EM radiation) received through an aperture 180 of the imaging device 105 and generate pixel values of the image based on the scene 175. An image may be referred to as a frame or an image frame. In some cases, the image detector circuit 165 may include an array of detectors (e.g., also referred to as an array of pixels) that can detect radiation of a certain waveband, convert the detected radiation into electrical signals (e.g., voltages, currents, etc.), and generate the pixel values based on the electrical signals. Each detector in the array may capture a respective portion of the image data and generate a pixel value based on the respective portion captured by the detector. The pixel value generated by the detector may be referred to as an output of the detector. By way of non-limiting examples, each detector may be a photodetector, such as an avalanche photodiode, an infrared photodetector, a quantum well infrared photodetector, a microbolometer, or other detector capable of converting EM radiation (e.g., of a certain wavelength) to a pixel value. The array of detectors may be arranged in rows and columns.

The detector output image may be, or may be considered, a data structure that includes pixels and is a representation of the image data associated with the scene 175, with each pixel having a pixel value that represents EM radiation emitted or reflected from a portion of the scene 175 and received by a detector that generates the pixel value. Based on context, a pixel may refer to a detector of the image detector circuit 165 that generates an associated pixel value or a pixel (e.g., pixel location, pixel coordinate) of the detector output image formed from the generated pixel values. In one example, the detector output image may be an infrared image (e.g., thermal infrared image). For a thermal infrared image (e.g., also referred to as a thermal image), each pixel value of the thermal infrared image may represent a temperature of a corresponding portion of the scene 175. In another example, the detector output image may be a visible-light image.

In an aspect, the pixel values generated by the image detector circuit 165 may be represented in terms of digital count values generated based on the electrical signals obtained from converting the detected radiation. For example, in a case that the image detector circuit 165 includes or is otherwise coupled to an analog-to-digital (ADC) circuit, the ADC circuit may generate digital count values based on the electrical signals. For an ADC circuit that can represent an electrical signal using 14 bits, the digital count value may range from 0 to 16,383. In such cases, the pixel value of the detector may be the digital count value output from the ADC circuit. In other cases (e.g., in cases without an ADC circuit), the pixel value may be analog in nature with a value that is, or is indicative of, the value of the electrical signal. As an example, for infrared imaging, a larger amount of IR radiation being incident on and detected by the image detector circuit 165 (e.g., an IR image detector circuit) is associated with higher digital count values and higher temperatures.

The readout circuit 170 may be utilized as an interface between the image detector circuit 165 that detects the image data and the logic device 110 that processes the detected image data as read out by the readout circuit 170, with communication of data from the readout circuit 170 to the logic device 110 facilitated by the image interface 125. An image capturing frame rate may refer to the rate (e.g., detector output images per second) at which images are detected/output in a sequence by the image detector circuit 165 and provided to the logic device 110 by the readout circuit 170. The readout circuit 170 may read out the pixel values generated by the image detector circuit 165 in accordance with an integration time (e.g., also referred to as an integration period).

In various embodiments, a combination of the image detector circuit 165 and the readout circuit 170 may be, may include, or may together provide an FPA. In some aspects, the image detector circuit 165 may be a thermal image detector circuit that includes an array of microbolometers, and the combination of the image detector circuit 165 and the readout circuit 170 may be referred to as a microbolometer FPA. In some cases, the array of microbolometers may be arranged in rows and columns. The microbolometers may detect IR radiation and generate pixel values based on the detected IR radiation. For example, in some cases, the microbolometers may be thermal IR detectors that detect IR radiation in the form of heat energy and generate pixel values based on the amount of heat energy detected. The microbolometers may absorb incident IR radiation and produce a corresponding change in temperature in the microbolometers. The change in temperature is associated with a corresponding change in resistance of the microbolometers. With each microbolometer functioning as a pixel, a two-dimensional image or picture representation of the incident IR radiation can be generated by translating the changes in resistance of each microbolometer into a time-multiplexed electrical signal. The translation may be performed by the ROIC. The microbolometer FPA may include IR detecting materials such as amorphous silicon (a-Si), vanadium oxide (VOx), a combination thereof, and/or other detecting material(s). In an aspect, for a microbolometer FPA, the integration time may be, or may be indicative of, a time interval during which the microbolometers are biased. In this case, a longer integration time may be associated with higher gain of the IR signal, but not more IR radiation being collected. The IR radiation may be collected in the form of heat energy by the microbolometers.

In some cases, the image capture component 120 may include one or more optical components and/or one or more filters. The optical component(s) may include one or more windows, lenses, mirrors, beamsplitters, beam couplers, and/or other components to direct and/or focus radiation to the image detector circuit 165. The optical component(s) may include components each formed of material and appropriately arranged according to desired transmission characteristics, such as desired transmission wavelengths and/or ray transfer matrix characteristics. The filter(s) may be adapted to pass radiation of some wavelengths but substantially block radiation of other wavelengths. For example, the image capture component 120 may be an IR imaging device that includes one or more filters adapted to pass IR radiation of some wavelengths while substantially blocking IR radiation of other wavelengths (e.g., MWIR filters, thermal IR filters, and narrow-band filters). In this example, such filters may be utilized to tailor the image capture component 120 for increased sensitivity to a desired band of IR wavelengths. In an aspect, an IR imaging device may be referred to as a thermal imaging device when the IR imaging device is tailored for capturing thermal IR images. Other imaging devices, including IR imaging devices tailored for capturing infrared IR images outside the thermal range, may be referred to as non-thermal imaging devices.

In one specific, not-limiting example, the image capture component 120 may include an IR imaging sensor having an FPA of detectors responsive to IR radiation including near infrared (NIR), SWIR, MWIR, LWIR, and/or very-long wave IR (VLWIR) radiation. In some other embodiments, alternatively or in addition, the image capture component 120 may include a complementary metal oxide semiconductor (CMOS) sensor or a charge-coupled device (CCD) sensor that can be found in any consumer camera (e.g., visible light camera).

In some embodiments, the imaging system 100 includes a shutter 185. The shutter 185 may be operated to selectively inserted into an optical path between the scene 175 and the image capture component 120 to expose or block the aperture 180. In some cases, the shutter 185 may be moved (e.g., slid, rotated, etc.) manually (e.g., by a user of the imaging system 100) and/or via an actuator (e.g., controllable by the logic device 110 in response to user input or autonomously, such as an autonomous decision by the logic device 110 to perform a calibration of the imaging device 105). When the shutter 185 is outside of the optical path to expose the aperture 180, the electromagnetic radiation from the scene 175 may be received by the image detector circuit 165 (e.g., via one or more optical components and/or one or more filters). As such, the image detector circuit 165 captures images of the scene 175. The shutter 185 may be referred to as being in an open position or simply as being open. When the shutter 185 is inserted into the optical path to block the aperture 180, the electromagnetic radiation from the scene 175 is blocked from the image detector circuit 165. As such, the image detector circuit 165 captures images of the shutter 185. The shutter 185 may be referred to as being in a closed position or simply as being closed. In some cases, the shutter 185 may block the aperture 180 during a calibration process, in which the shutter 185 may be used as a uniform blackbody (e.g., a substantially uniform blackbody). In some cases, the shutter 185 may be temperature controlled to provide a temperature controlled uniform black body (e.g., to present a uniform field of radiation to the image detector circuit 165). For example, in some cases, a surface of the shutter 185 imaged by the image detector circuit 165 may be implemented by a uniform blackbody coating.

Other imaging sensors that may be embodied in the image capture component 120 include a photonic mixer device (PMD) imaging sensor or other time of flight (ToF) imaging sensor, LIDAR imaging device, RADAR imaging device, millimeter imaging device, positron emission tomography (PET) scanner, single photon emission computed tomography (SPECT) scanner, ultrasonic imaging device, or other imaging devices operating in particular modalities and/or spectra. It is noted that for some of these imaging sensors that are configured to capture images in particular modalities and/or spectra (e.g., infrared spectrum, etc.), they are more prone to produce images with low frequency shading, for example, when compared with a typical CMOS-based or CCD-based imaging sensors or other imaging sensors, imaging scanners, or imaging devices of different modalities.

The images, or the digital image data corresponding to the images, provided by the image capture component 120 may be associated with respective image dimensions (also referred to as pixel dimensions). An image dimension, or pixel dimension, generally refers to the number of pixels in an image, which may be expressed, for example, in width multiplied by height for two-dimensional images or otherwise appropriate for relevant dimension or shape of the image. Thus, images having a native resolution may be resized to a smaller size (e.g., having smaller pixel dimensions) in order to, for example, reduce the cost of processing and analyzing the images. Filters (e.g., a non-uniformity estimate) may be generated based on an analysis of the resized images. The filters may then be resized to the native resolution and dimensions of the images, before being applied to the images.

The image interface 125 may include, in some embodiments, appropriate input ports, connectors, switches, and/or circuitry configured to interface with external devices (e.g., a remote device 155 and/or other devices) to receive images (e.g., digital image data) generated by or otherwise stored at the external devices. In an aspect, the image interface 125 may include a serial interface and telemetry line for providing metadata associated with image data. The received images or image data may be provided to the logic device 110. In this regard, the received images or image data may be converted into signals or data suitable for processing by the logic device 110. For example, in one embodiment, the image interface 125 may be configured to receive analog video data and convert it into suitable digital data to be provided to the logic device 110.

The image interface 125 may include various standard video ports, which may be connected to a video player, a video camera, or other devices capable of generating standard video signals, and may convert the received video signals into digital video/image data suitable for processing by the logic device 110. In some embodiments, the image interface 125 may also be configured to interface with and receive images (e.g., image data) from the image capture component 120. In other embodiments, the image capture component 120 may interface directly with the logic device 110.

The control component 130 includes, in one embodiment, a user input and/or an interface device, such as a rotatable knob (e.g., potentiometer), push buttons, slide bar, keyboard, and/or other devices, that is adapted to generate a user input control signal. The logic device 110 may be configured to sense control input signals from a user via the control component 130 and respond to any sensed control input signals received therefrom. The logic device 110 may be configured to interpret such a control input signal as a value, as generally understood by one skilled in the art. In one embodiment, the control component 130 may include a control unit (e.g., a wired or wireless handheld control unit) having push buttons adapted to interface with a user and receive user input control values. In one implementation, the push buttons and/or other input mechanisms of the control unit may be used to control various functions of the imaging device 105, such as calibration initiation and/or related control, shutter control, autofocus, menu enable and selection, field of view, brightness, contrast, noise filtering, image enhancement, and/or various other features. In some cases, the control component 130 may be used to provide user input (e.g., for adjusting image settings).

The display component 135 includes, in one embodiment, an image display device (e.g., a liquid crystal display (LCD)) or various other types of generally known video displays or monitors. The logic device 110 may be configured to display image data and information on the display component 135. The logic device 110 may be configured to retrieve image data and information from the memory component 115 and display any retrieved image data and information on the display component 135. The display component 135 may include display circuitry, which may be utilized by the logic device 110 to display image data and information. The display component 135 may be adapted to receive image data and information directly from the image capture component 120, logic device 110, and/or image interface 125, or the image data and information may be transferred from the memory component 115 via the logic device 110. In some aspects, the control component 130 may be implemented as part of the display component 135. For example, a touchscreen of the imaging device 105 may provide both the control component 130 (e.g., for receiving user input via taps and/or other gestures) and the display component 135 of the imaging device 105.

The sensing component 140 includes, in one embodiment, one or more sensors of various types, depending on the application or implementation requirements, as would be understood by one skilled in the art. Sensors of the sensing component 140 provide data and/or information to at least the logic device 110. In one aspect, the logic device 110 may be configured to communicate with the sensing component 140. In various implementations, the sensing component 140 may provide information regarding environmental conditions, such as outside temperature, lighting conditions (e.g., day, night, dusk, and/or dawn), humidity level, specific weather conditions (e.g., sun, rain, and/or snow), distance (e.g., laser rangefinder or time-of-flight camera), and/or whether a tunnel or other type of enclosure has been entered or exited. The sensing component 140 may represent conventional sensors as generally known by one skilled in the art for monitoring various conditions (e.g., environmental conditions) that may have an effect (e.g., on the image appearance) on the image data provided by the image capture component 120.

In some implementations, the sensing component 140 (e.g., one or more sensors) may include devices that relay information to the logic device 110 via wired and/or wireless communication. For example, the sensing component 140 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques. In some embodiments, the logic device 110 can use the information (e.g., sensing data) retrieved from the sensing component 140 to modify a configuration of the image capture component 120 (e.g., adjusting a light sensitivity level, adjusting a direction or angle of the image capture component 120, adjusting an aperture, etc.). The sensing component 140 may include a temperature sensing component to provide temperature data (e.g., one or more measured temperature values) various components of the imaging device 105, such as the image detection circuit 165 and/or the shutter 185. By way of non-limiting examples, a temperature sensor may include a thermistor, thermocouple, thermopile, pyrometer, and/or other appropriate sensor for providing temperature data.

In some embodiments, various components of the imaging system 100 may be distributed and in communication with one another over a network 160. In this regard, the imaging device 105 may include a network interface 145 configured to facilitate wired and/or wireless communication among various components of the imaging system 100 over the network 160. In such embodiments, components may also be replicated if desired for particular applications of the imaging system 100. That is, components configured for same or similar operations may be distributed over a network. Further, all or part of any one of the various components may be implemented using appropriate components of the remote device 155 (e.g., a conventional digital video recorder (DVR), a computer configured for image processing, and/or other device) in communication with various components of the imaging system 100 via the network interface 145 over the network 160, if desired. Thus, for example, all or part of the logic device 110, all or part of the memory component 115, and/or all of part of the display component 135 may be implemented or replicated at the remote device 155. In some embodiments, the imaging system 100 may not include imaging sensors (e.g., image capture component 120), but instead receive images or image data from imaging sensors located separately and remotely from the logic device 110 and/or other components of the imaging system 100. It will be appreciated that many other combinations of distributed implementations of the imaging system 100 are possible, without departing from the scope and spirit of the disclosure.

Furthermore, in various embodiments, various components of the imaging system 100 may be combined and/or implemented or not, as desired or depending on the application or requirements. In one example, the logic device 110 may be combined with the memory component 115, image capture component 120, image interface 125, display component 135, sensing component 140, and/or network interface 145. In another example, the logic device 110 may be combined with the image capture component 120, such that certain functions of the logic device 110 are performed by circuitry (e.g., a processor, a microprocessor, a logic device, a microcontroller, an NPU, etc.) within the image capture component 120.

In an embodiment, the remote device 155 may be referred to as a host device. The host device may communicate with the image device 105 via the network interface 145 and the network 160. For example, the imaging device 105 may be a camera that can communicate with the remote device 155. The network interface 145 and the network 160 may collectively provide appropriate interfaces, ports, connectors, switches, antennas, circuitry, and/or generally any other components of the imaging device 105 and the remote device 155 to facilitate communication between the imaging device 105 and the remote device 155. Communication interfaces may include an Ethernet interface (e.g., Ethernet GigE interface, Ethernet GigE Vision interface), a universal serial bus (USB) interface, other wired interface, a cellular interface, a Wi-Fi interface, other wireless interface, or generally any interface to allow communication of data between the imaging device 105 and the remote device 155.

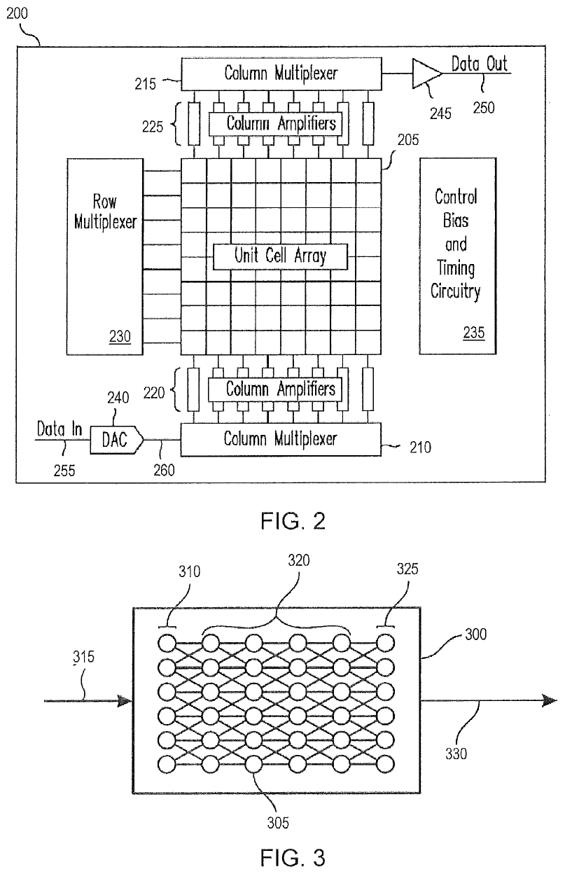

FIG. 2 illustrates a block diagram of an example image sensor assembly 200 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. In an embodiment, the image sensor assembly 200 may be an FPA, for example, implemented as the image capture component 120 of FIG. 1.

The image sensor assembly 200 includes a unit cell array 205, column multiplexers 210 and 215, column amplifiers 220 and 225, a row multiplexer 230, control bias and timing circuitry 235, a digital-to-analog converter (DAC) 240, and a data output buffer 245. In some aspects, operations of and/or pertaining to the unit cell array 205 and other components may be performed according to a system clock and/or synchronization signals (e.g., line synchronization (LSYNC) signals). The unit cell array 205 includes an array of unit cells. In an aspect, each unit cell may include a detector (e.g., a pixel) and interface circuitry. The interface circuitry of each unit cell may provide an output signal, such as an output voltage or an output current, in response to a detection signal (e.g., detection current, detection voltage) provided by the detector of the unit cell. The output signal may be indicative of the magnitude of EM radiation received by the detector and may be referred to as image pixel data or simply image data. The column multiplexer 215, column amplifiers 220, row multiplexer 230, and data output buffer 245 may be used to provide the output signals from the unit cell array 205 as a data output signal on a data output line 250. The output signals on the data output line 250 may be provided to components downstream of the image sensor assembly 200, such as processing circuitry (e.g., the logic device 110 of FIG. 1), memory (e.g., the memory component 115 of FIG. 1), display device (e.g., the display component 135 of FIG. 1), and/or other component to facilitate processing, storage, and/or display of the output signals. The data output signal may be an image formed of the pixel values for the image sensor assembly 200. In this regard, the column multiplexer 215, the column amplifiers 220, the row multiplexer 230, and the data output buffer 245 may collectively provide an ROIC (or portion thereof) of the image sensor assembly 200. In an aspect, the interface circuitry may be considered part of the ROIC, or may be considered an interface between the detectors and the ROIC. In some embodiments, components of the image sensor assembly 200 may be implemented such that the unit cell array 205 and the ROIC may be part of a single dic.

The column amplifiers 225 may generally represent any column processing circuitry as appropriate for a given application (analog and/or digital), and is not limited to amplifier circuitry for analog signals. In this regard, the column amplifiers 225 may more generally be referred to as column processors in such an aspect. Signals received by the column amplifiers 225, such as analog signals on an analog bus and/or digital signals on a digital bus, may be processed according to the analog or digital nature of the signal. As an example, the column amplifiers 225 may include circuitry for processing digital signals. As another example, the column amplifiers 225 may be a path (e.g., no processing) through which digital signals from the unit cell array 205 traverses to get to the column multiplexer 215. As another example, the column amplifiers 225 may include an ADC for converting analog signals to digital signals (e.g., to obtain digital count values). These digital signals may be provided to the column multiplexer 215.

Each unit cell may receive a bias signal (e.g., bias voltage, bias current) to bias the detector of the unit cell to compensate for different response characteristics of the unit cell attributable to, for example, variations in temperature, manufacturing variances, and/or other factors. For example, the control bias and timing circuitry 235 may generate the bias signals and provide them to the unit cells. By providing appropriate bias signals to each unit cell, the unit cell array 205 may be effectively calibrated to provide accurate image data in response to light (e.g., visible-light, IR light) incident on the detectors of the unit cells. In an aspect, the control bias and timing circuitry 235 may be, may include, or may be a part of, a logic circuit.

The control bias and timing circuitry 235 may generate control signals for addressing the unit cell array 205 to allow access to and readout of image data from an addressed portion of the unit cell array 205. The unit cell array 205 may be addressed to access and readout image data from the unit cell array 205 row by row, although in other implementations the unit cell array 205 may be addressed column by column or via other manners.

The control bias and timing circuitry 235 may generate bias values and timing control voltages. In some cases, the DAC 240 may convert the bias values received as, or as part of, data input signal on a data input signal line 255 into bias signals (e.g., analog signals on analog signal line(s) 260) that may be provided to individual unit cells through the operation of the column multiplexer 210, column amplifiers 220, and row multiplexer 230. For example, the DAC 240 may drive digital control signals (e.g., provided as bits) to appropriate analog signal levels for the unit cells. In some technologies, a digital control signal of 0 or 1 may be driven to an appropriate logic low voltage level or an appropriate logic high voltage level, respectively. In another aspect, the control bias and timing circuitry 235 may generate the bias signals (e.g., analog signals) and provide the bias signals to the unit cells without utilizing the DAC 240. In this regard, some implementations do not include the DAC 240, data input signal line 255, and/or analog signal line(s) 260. In an embodiment, the control bias and timing circuitry 235 may be, may include, may be a part of, or may otherwise be coupled to the logic device 110 and/or image capture component 120 of FIG. 1.

In an embodiment, the image sensor assembly 200 may be implemented as part of an imaging device (e.g., the imaging device 105). In addition to the various components of the image sensor assembly 200, the imaging device may also include one or more processors, memories, logic, displays, interfaces, optics (e.g., lenses, mirrors, beamsplitters), and/or other components as may be appropriate in various implementations. In an aspect, the data output signal on the data output line 250 may be provided to the processors (not shown) for further processing. For example, the data output signal may be an image formed of the pixel values from the unit cells of the image sensor assembly 200. The processors may perform operations such as non-uniformity correction (e.g., flat-field correction or other calibration technique), spatial and/or temporal filtering, and/or other operations. The images (e.g., processed images) may be stored in memory (e.g., external to or local to the imaging system) and/or displayed on a display device (e.g., external to and/or integrated with the imaging system). The various components of FIG. 2 may be implemented on a single chip or multiple chips. Furthermore, while the various components are illustrated as a set of individual blocks, various of the blocks may be merged together or various blocks shown in FIG. 2 may be separated into separate blocks.

It is noted that in FIG. 2 the unit cell array 205 is depicted as an 8×8 (e.g., 8 rows and 8 columns of unit cells. However, the unit cell array 205 may be of other array sizes. By way of non-limiting examples, the unit cell array 205 may include 512×512 (e.g., 512 rows and 512 columns of unit cells), 1024×1024, 2048×2048, 4096×4096, 8192×8192, and/or other array sizes. In some cases, the array size may have a row size (e.g., number of detectors in a row) different from a column size (e.g., number of detectors in a column). Examples of frame rates may include 30 Hz, 60 Hz, and 120 Hz. In an aspect, each unit cell of the unit cell array 205 may represent a pixel.

Various aspects of the present disclosure may be implemented to use and train neural networks, decision tree-based machine models, and/or other machine learning models. Such models may be used to analyze captured image data and determine image settings and may be adjusted/updated responsive to user input regarding the image settings.

As an example of a machine learning model used and updated in accordance with embodiments herein, FIG. 3 illustrates a block diagram of a neural network 300 (e.g., an artificial neural network) in accordance with one or more embodiments of the present disclosure. In an aspect, the neural network 300 may be a CNN. In an embodiment, the neural network 300 may be implemented by the logic device 110. The neural network 300 may be used to process image data to determine image settings. In some cases, the neural network 300 may detect/identify scene background features, potential targets of interest (e.g., objects, persons, and/or portions thereof) in a scene (e.g., as represented in an image), provide characteristics of the potential targets (e.g., location of the potential targets, temperature of the potential targets), and determine the image settings based at least on such detections. As an example, the targets of interest may include electronic equipment (e.g., wires, circuit boards, fuse cabinets) in applications such as industrial inspection applications. An operator in such applications may be a person monitoring for potentially faulty equipment.

As shown, the neural network 300 includes various nodes 305 (e.g., neurons) arranged in multiple layers including an input layer 310 receiving one or more inputs 315, hidden layers 320, and an output layer 325 providing one or more outputs 330. The input(s) 315 may collectively provide a training dataset for use in training the neural network 300. Although particular numbers of nodes 305 and layers 310, 320, and 325 are shown, any desired number of such features may be provided in various embodiments. The training dataset may include images, image settings associated with the images, and/or user input (or lack thereof) in association with the image settings. In some cases, the images may be formed of registered visible-light and infrared pairs. In some embodiments, the neural network 300 may be trained to determine one or more image settings and provide the image setting(s) as the output(s) 330.

In some embodiments, the neural network 300 operates as a multi-layer classification tree using a set of non-linear transformations between the various layers 310, 320, and/or 325 to extract features and information from images (e.g., thermal images) by an imager (e.g., the imaging device 105). For example, the neural network 300 may be trained on large amounts of data. Such data may include image data (e.g., thermal images, visible-light images, combined images generated from thermal images and visible-light images), geoposition data, camera orientation data, temperature data of internal camera components, distance data to objects in the scene, and/or other data. This iterative procedure is repeated until the neural network 300 has trained on enough data such that the neural network 300 can perform predictions of its own.

The neural network 300 may be used to perform target detection (e.g., detection for pre-established targets) and additional characteristic detection on various images (e.g., thermal images) captured by the imaging system 100 and provided to the input(s) 315 of the neural network 300. The neural network 300 may be trained by providing image data (e.g., thermal images, visible-light images, combined images generated from thermal images and visible-light images) and/or other data of known targets (e.g., circuit boards, fuse boxes) with known characteristics (e.g., images and related information regarding the characteristics may be stored in a database associated with training neural networks) to the input(s) 315.

In some embodiments, detected potential targets, associated characteristics, image settings, and/or other data obtained by analyzing images using the neural network 300 may be presented (e.g., displayed) to an operator, such as to provide the operator an opportunity to review the data and provide user input to adjust the data as appropriate. The user input may be analyzed and fed back (e.g., along with the image settings that caused the user input) to update a training dataset used to train the neural network 300. In this regard, the user input may be provided in a backward pass through the neural network 300 to update neural network parameters based on the user input. In some aspects, the backward pass may include back propagation and gradient descent. In some cases, the presence of user input with regard to a given image setting output by the neural network 300 may indicate that the user has determined the image setting to be in error (e.g., not correct to the user). In some cases, the lack of user input with regard to a given image setting may indicate that the user has determined the image setting to not be in error (e.g., sufficiently correct for the user). Adjustment of the training dataset (e.g., by removing prior training data, adding new training data, and/or otherwise adjusting existing training data) may allow for improved accuracy (e.g., on-the-fly). In some aspects, by adjusting the training dataset to improve accuracy, the user may avoid costly delays in implementing accurate feature classifications, image setting determinations, and so forth.

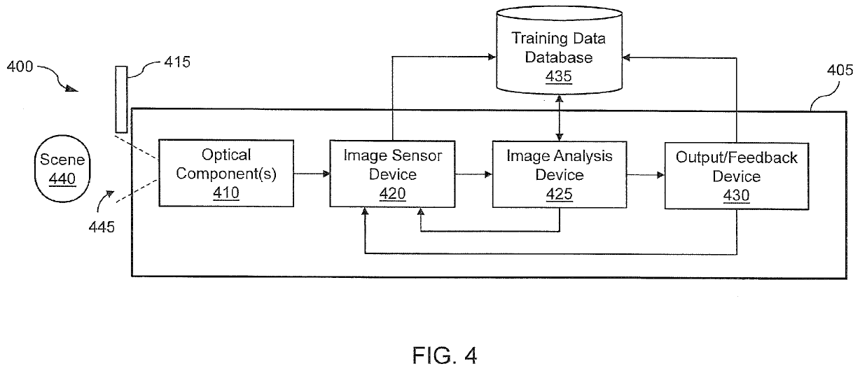

FIG. 4 illustrates an example system 400 for facilitating image setting determination and machine learning for infrared imaging in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided.

The system 400 includes a housing 405 (e.g., a camera body), one or more optical components 410, a shutter 415, an image sensor device 420, an image analysis device 425, an output/feedback device 430, and a training data database 435. In an embodiment, the optical component(s) 410, the shutter 415, the image sensor device 420, the image analysis device 425, and the output/feedback device 430 may be implemented using one or more processing circuits on a single chip or distributed across two or more chips. The system 400 may be, may include, or may be a part of, an infrared imaging system used to capture and process images. In an embodiment, the infrared imaging system may be, may include, or may be a part of, the imaging system 100 of FIG. 1.

Although in FIG. 4 the optical component(s) 410, the image sensor device 420, the image analysis device 425, and the output/feedback device 430 are within the housing 405, in some embodiments the housing 405 include more, fewer, and/or different components. As an example, in some cases, the housing 405 may be a camera housing that includes the optical component(s) 410, the shutter 415, and the image sensor device 420, whereas the image analysis device 425 may be separate from the camera and communicatively connected (e.g., wirelessly or wired) to the camera to receive data from and transmit data to the camera.

The optical component(s) 410 may receive electromagnetic radiation from a scene 440 through an aperture 445 of the system 400 and pass the electromagnetic radiation to the image sensor device 420. For example, the optical component(s) 410 may direct and/or focus the electromagnetic radiation on the image sensor device 420. The optical component(s) 410 may include one or more windows, lenses, mirrors, beamsplitters, beam couplers, and/or other components. The optical component(s) 410 may include components each formed of material and appropriately arranged according to desired transmission characteristics, such as desired transmission wavelengths and/or ray transfer matrix characteristics.

The shutter 415 may be operated to selectively expose or block the aperture 445. When the shutter 415 is positioned to expose the aperture 445, the electromagnetic radiation from the scene 440 may be received and directed by the optical component(s) 410. When the shutter 415 is positioned to block the aperture 445, the electromagnetic radiation from the scene 440 is blocked from the optical component(s) 410. In some cases, the shutter 415 may block the aperture 445 during a calibration process, in which the shutter 415 may be used as a uniform blackbody.

The image sensor device 420 may include one or more FPAs. In some aspects, an FPA includes a detector array and an ROIC. The FPA may receive the electromagnetic radiation from the optical component(s) 410 and generate image data based on the electromagnetic radiation. The image data may include infrared data values (e.g., thermal infrared data values). As an example, the FPA may include or may be coupled to an ADC circuit that generates infrared data values based on infrared radiation. A 16-bit ADC circuit may generate infrared data values that range from 0 to 65,535. The infrared data values may provide temperature data (e.g., estimated temperature values) for different portions of the scene 440, such as provide temperatures of objects, persons, other features/aspects in the scene 440, and/or portions thereof. In some cases, alternative or in addition to an FPA, the image sensor device 420 may include one or more sensors in one or more non-infrared wavebands, such as visible-light sensors.

The image analysis device 425 may receive the image data (e.g., the infrared data values) and generate an images and determine image settings based on the image data. In an embodiment, the image analysis device 425 may be implemented by the logic device 110 of the imaging device 105 (e.g., a camera) and/or a logic device of the remote device 155. In this regard, in some cases, the processing may be distributed across the imaging device 105 and the remote device 155).

The image analysis device 425 may analyze the image data and classify automatically (e.g., using a trained neural network) and/or manually (e.g., using user input received via a user interface) one or more targets (e.g., objects, persons, and/or other features being detected for) in the images. As such, analytics may indicate targets detected in the scene 440 and determine characteristics (e.g., size, shape, temperature profile) associated with the targets. In this regard, the image analysis device 425 may be trained to detect for one or more target types (e.g., a circuit board, a human or portion thereof such as a human face, a car, a plane) by performing target detection/recognition on the image data based upon, for example, shapes, sizes, thermal characteristics, and/or other characteristics identified in the scene 440 by the image analysis device 425.

In some aspects, the image analysis device 425 may associate a condition with a target detected in the image data. Associating a condition with a target may be referred to as determining (e.g., guessing) a condition of the target. In this regard, the image analysis device 425 may be appropriately trained to determine a presence of a condition. As an example, the image analytics device 425 may perform target detection to identify a particular electrical circuit (e.g., a circuit the image analytics device 425 is trained to analyze) in an image and conditions associated with the electrical circuit. For the electrical circuit, the image analysis device 425 may, based on thermal characteristics of the electrical circuit, determine whether the electrical circuit is in a sleep mode, is in normal operation, is heavily utilized, is overheating, is sparking, and/or is encountering other situations. In some cases, to facilitate faulty equipment assessment, a shape, a size, and thermal characteristics may be used together to identify faults if any, determine a severity of each fault, and/or generate a recommended course of action (e.g., repair, contact professional, replace, etc.).

In an embodiment, the image analysis device 425 may perform target detection based on appropriately trained neural networks (e.g., CNNs). In some cases, such trained neural networks may also determine a condition(s) associated with a detected target(s). As an example, the image analysis device 425 may implement the neural network 300 and/or other neural networks. In some cases, the image analysis device 425 may associate each target detection by the image analysis device 425 with a confidence level (e.g., indicative of a probability that the image analysis device 425 correctly identifies/classifies a feature in an image as being a certain target type) and each condition determination/association for the target by the image analysis device 425 with a confidence level (e.g., indicative of a probability that the image analysis device 425 correctly determines/associates a condition (e.g., properly operating equipment or faulty equipment)).

The image analysis device 425 may generate image settings associated with the analytics. An image setting may include, by way of non-limiting examples, a measurement function (e.g., spots, boxes, lines, circles, polygons, polylines), an image parameter (e.g., emissivity, reflected temperature, distance, atmospheric temperature, external optics temperature, external optics transmissivity), palette (e.g., color palette, grayscale palette), a temperature alarm (e.g., type of alarm, threshold levels), a fusion mode (e.g., thermal/visual only, blending, fusion, PIP)), a fusion setting (e.g., alignment, PIP placement), level and span/gain control, zoom/cropping, an equipment type classification, a fault classification, a recommended action, text annotation/note, and/or others.

The image analysis device 425 may generate the image based on one or more palettes indicated by one or more of the image settings. In this regard, the image may provide a representation of the infrared image data according to a palette, such that a visual representation value (e.g., color value or grayscale value) of each pixel of the image is indicative of a temperature associated with that pixel. In some cases, the image (and temperature data represented therein) may be based in part on image settings such as emissivity(ies) of object(s), reflected temperature(s), distance(s) between object(s) and the image sensor device 425, atmospheric temperature(s), and so forth. Accurate assessment of such image settings may allow for more accurate temperature values represented in the image.

The image analysis device 425 may generate indications of the image settings. An indication may be a visual indication, an audio indication, and/or other type of indication. In some cases, the image setting may include annotations on an image to be presented to the user. Alternatively or in addition to such visual indications (e.g., the annotated images), an audio indication may be provided. As an example, an audio indication may include a first notification sound or no sound when no faults are detected in inspected equipment or a second notification sound when any part of the equipment is determined not to be operating properly. As an example, a tactile indication may be a 3D print out (e.g., 3D Braille print out) to provide the same or similar data as provided in the examples above by the visual indication and audio indication. In this regard, indications may be in the form of text, icons, colors, flashing lights, sounds, alarms, and/or other indication types to be provided using the various components as appropriate.

The output/feedback device 430 may provide indications of the image settings to the user. In an embodiment, the output/feedback device 430 may be implemented by the processing component 110, the control component 130, and/or the display component 135 of the imaging device 105 (e.g., a camera) and/or a processing component, a control component, and/or a display component of the remote device 155 (e.g., a host device). In this regard, in some cases, the providing of the indication may be distributed across the imaging device 105 and the remote device 155). As non-limiting examples, the output/feedback device 430 may include a display device (e.g., monitor) to display visual indications (e.g., annotated images), an audio device (e.g., speakers) to emit audio indications, and so forth.

In some embodiments, the output/feedback device 430 may provide appropriate user interfaces to receive user input as feedback. The feedback may include feedback associated with the indications. The user of the system 400 may review the image settings determined (e.g., automatically determined) by the image analysis device 425 (e.g., as presented to the user using the indications) and confirm and/or edit the image settings. As an example, a user of the system 400 may confirm and/or edit annotations in the annotated images, remove annotations, and/or add new annotations. Such confirmations, edits, removals, and/or additions may be considered feedback. In some aspects, the image settings determined by the image analysis device 425, the user input, and/or the images may collectively form a training dataset used as input for training one or more machine learning models.

Training datasets associated with training machine learning models may be stored (e.g., in memories, databases, etc.). Such storage may be local to the devices and/or systems and/or remote from the devices and/or systems, such as a remote server(s)/database(s) accessible via a local area network and/or a cloud service. In FIG. 4, the training data dataset 435 may store image data captured by the image sensor device 420, analytics and/or image settings generated by the image analysis device 425, feedback (e.g., user feedback) received by the output/feedback device 430, and/or other data. In some cases, the training datasets stored in the training data database 435 may be used to train the machine learning model(s) (e.g., neural network(s), decision tree-based model(s)) implemented by the system 400 (e.g., the image analysis device 425 of the system 400) and/or other imaging systems.

In some cases, the image analysis device 425 and/or the output/feedback device 430 may provide their respective outputs to the image sensor device 420. As non-limiting examples, the outputs of the image analysis device 420 and/or the output/feedback device 425 may cause adjustment of an integration time, applied bias signals, and/or other image capturing parameters of the image sensor device 420 (e.g., generally dependent on sensor technology) to provide a desired dynamic range, temperature sensitivity, and/or other characteristics.

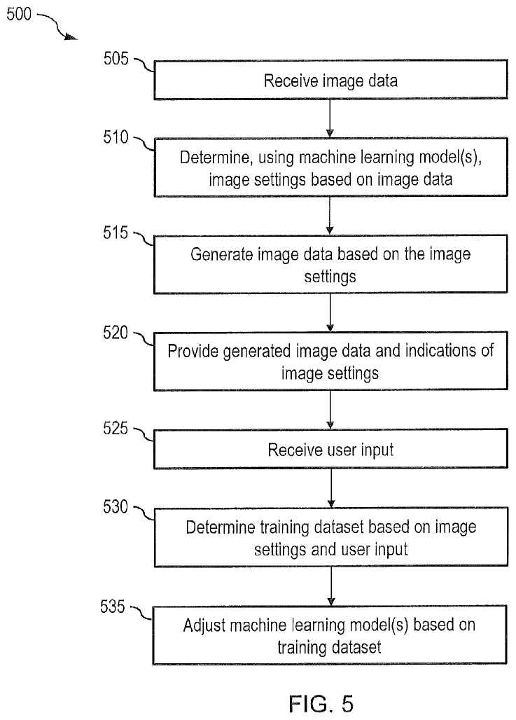

FIG. 5 illustrates a flow diagram of an example process 500 for facilitating image setting determination and machine learning for infrared imaging in accordance with one or more embodiments of the present disclosure. Although the process 500 is primarily described herein with reference to the system 400 of FIG. 4 for explanatory purposes, the process 500 can be performed in relation to other systems for facilitating image setting determination and associated machine learning for infrared imaging. Note that one or more operations in FIG. 5 may be combined, omitted, and/or performed in a different order as desired.

At block 505, the image analysis device 425 receives image data (e.g., infrared image data). The image analysis device 425 may be implemented in an imaging system (e.g., the imaging system 100) that captures the image data, one or more devices remote from the imaging system (e.g., the remote device 155), or the imaging system and the remote device(s) (e.g., processing distributed across the imaging system and the remote device(s)). As one example, the image data may be received from the image sensor device 420 of the system 400. The image sensor device 420 may capture the image data in response to radiation (e.g., visible-light radiation and/or infrared radiation) of a scene (e.g., the scene 440) received by the image sensor device 420. In some cases, the image sensor device 420 and/or circuitry coupled to the image sensor device 420 may convert the radiation into electrical signals (e.g., voltages, currents, etc.) and generate pixel values based on the electrical signals. In an aspect, the pixel values generated by the image sensor device and/or associated circuitry may be represented in terms of digital count values generated based on the electrical signals obtained from converting the detected infrared radiation. For example, in a case that the image sensor device includes or is otherwise coupled to an ADC circuit, the ADC circuit may generate digital count values based on the electrical signals for each color channel. As another example, the image analysis device 425 may receive or retrieve the image data from an image sensor device external to the imaging system and/or a memory (e.g., the memory component 110) of the imaging system or other system that stores captured images.

At block 510, the image analysis device 425 determines image settings based on the image data. The image analysis device 425 may use one or more trained machine learning models to determine the image settings based on the image data. By way of non-limiting examples, an image setting may include an image parameter (e.g., emissivity, reflected temperature, distance, atmospheric temperature, external optics temperature, external optics transmission), a measurement function (e.g., spots, boxes, lines, circles, polygons, polylines), a color palette, a grayscale palette, a temperature alarm (e.g., a type of alarm, threshold levels), a fusion mode (e.g., thermal only, visible-light only, blending, fusion, picture-in-picture), a fusion setting (e.g., alignment, picture-in-picture placement), level and span/gain control, zoom, cropping, an equipment type classification, a fault classification, a recommended action, and a text annotation/note. In some cases, the image settings may be based on sensor data from one or more sensors. In this regard, the machine learning model(s) may receive the sensor data as input for use in determining the image settings. A sensor may include a temperature sensor (e.g., to measure internal components of the image sensor device 425), a distance measurement device (e.g., laser measurement device, time-of-flight camera), and/or a geoposition device (e.g., GPS).

In some cases, the image analysis device 425 may determine analytics associated with the image data and determine one or more of the image settings based on the analytics. In this regard, the image analysis device 425 may analyze the image and detect for one or more object types (e.g., wire, circuit board) by performing target detection/recognition on the image data. Such target detection/recognition may be based upon, for example, shapes, sizes, thermal characteristics, and/or other characteristics identified in the scene 440 by the image analysis device 425. In some cases, the image analysis device 425 may associate a condition (e.g., a fault severity assessment) with an object detected in the image.

As an example, the trained machine learning model(s) may perform target recognition (e.g., based on object shape, size, and/or temperature profile) to identify targets of interest (e.g., potentially faulty wires, overheating circuit components). For each target, the trained machine learning model(s) may determine (e.g., predict, estimate) an associated emissivity(ies), an associated reflected temperature, a distance (e.g., an average distance) from the object to the image sensor device, a fault severity assessment, a temperature alarm (e.g., type, color, threshold level), an equipment type classification, an annotation (e.g., text, pictorial), a measurement location(s), a measurement function(s), and/or other image settings. In some cases, alternatively or in addition, the trained machine learning model(s) may determine a palette(s) (e.g., color palettes, greyscale palettes) to appropriately represent scene content, a fault severity assessment(s) based on any detected faults, and a recommended action(s) based on any fault severity assessments.

At block 515, the image analysis device 425 generates image data based on the image settings. The image data generated by the image analysis device 425 may include an infrared image, indications of the image settings, temperature data associated with a portion of the scene 440 based on one or more of the image settings (e.g., a measurement location and a measurement function), and/or other data. In some cases, pixel data values (e.g., temperature values) associated with pixels of the image data may be determined (e.g., estimated) based on the image settings (e.g., determined by the image analysis device 425 at block 510) associated with the pixels, such as an emissivity and/or a reflected temperature associated with an object encompassed by the pixels, a distance from the image sensor device to these pixels, an atmospheric/ambient temperature, external optics temperature, external optics transmissivity, a relative humidity, and/or others. In some cases, an image setting may set a palette (e.g., color palette) to be applied to the image data to generate the infrared image

As an example, a set of image settings may identify a location(s) of the scene 440 (as represented in the image data) and a measurement function(s) used to generate the temperature data for the location(s). Each location may be provided as a row coordinate(s) and a column coordinate(s). A measurement function may indicate pixels of the image data used to generate the temperature data for a given location. As an example, dependent on implementation, a spot measurement may provide a temperature value associated with a single pixel or a temperature value (e.g., an average temperature value) associated with a small group of pixels. As another example, a polygon-shaped measurement may provide an average temperature value, a minimum temperature value (e.g., lowest pixel value), and/or a maximum temperature value (e.g., highest pixel value) associated with a polygon about the location of the scene 440.

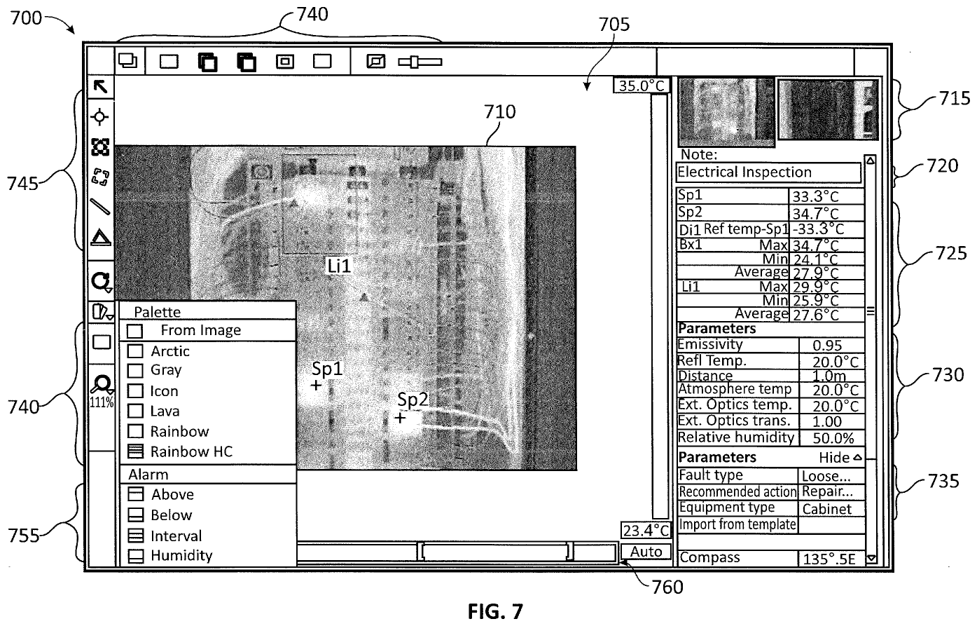

At block 520, the output/feedback device 430 may provide the image data generated by the image analysis device 425 and the indications of the image settings. The indication may be a visual indication, an audio indication, a tactile indication, and/or other type of indication. As one example, the output/feedback device 425 may include a display device to display an annotated image (e.g., the image generated by the image analysis device 425 with one or more image settings overlaid on the image). As another example, the display device may display one or more image settings separate from the image. An example graphical user interface for providing the image data and the indications is described with respect to FIG. 7.

At block 525, the output/feedback device 430 may receive user input associated with one or more of the image settings determined by the image analysis device 425. For example, the output/feedback device 430 may display the indications to the user along with or followed by a user interface (e.g., touch screen, fields of an evaluation form) to request feedback from the user. The user feedback may include user adjustments to and/or user comments regarding the image settings determined by the image analysis device 425. Such user feedback may be used to adjust operation of, models used by, and/or other aspects of the system 400. In this regard, the image settings determined by the image analysis device 425 using the trained machine learning model(s) may be referred to as predicted image settings or predicted correct image settings and corresponding image settings provided by the user to adjust the predicted image settings may be referred to as target image settings. As an example, when the image analysis device 425 generates an annotated image, the user may edit and/or confirm existing annotations by the image analysis device 425, remove annotations, and/or add annotations. In some cases, the user does not provide input. In some cases, lack of input from the user may be considered user input, since lack of feedback may indicative that no adjustments to measurement determinations (e.g., temperature models), measurement locations, and/or camera operation are needed. In some cases, the output/feedback device 430 may determine for a given image setting, using a loss function associated with the image setting, a difference between the predicted image setting and the user input indicative of the target image setting.

At block 530, the image sensor device 420, the image analysis device 425, and/or the output/feedback device 425 may determine a training dataset for storage and use in training one or more machine learning models. The training dataset may include images and/or associated analytics generated by the image analysis device 425, the image settings and/or indications thereof, the user input, and/or other associated data (e.g., camera's geoposition and orientation, ambient temperature, ambient humidity, timestamp). The training dataset may be stored in the training data database 435. As an example, the data may include images with annotations by the image analytics device 420 and/or manual user annotations. In some cases, the machine learning model(s) may be trained with large training datasets including thousands of images. In this regard, the machine learning model(s) may be evaluated correctness of its image settings (e.g., based on any received user input) on new image data from a dataset not part of the training dataset. Once the machine learning model(s) is tested using the new image data (e.g., including the image generated at block 515), the new image data may be stored in the training dataset.

At block 535, the image analysis device 425 may adjust one or more machine learning models based on the training dataset to obtain one or more adjusted/updated machine learning models. In this regard, parameters of one or more machine learning model(s) may be adjusted (e.g., using training methods such as back propagation and gradient descent) based at least on the loss function. In some embodiments, the updated machine learning model(s) may be used when analyzing subsequently received image data and determining image settings for the subsequently received image data, and may be updated responsive to user input to the subsequently determined image settings.

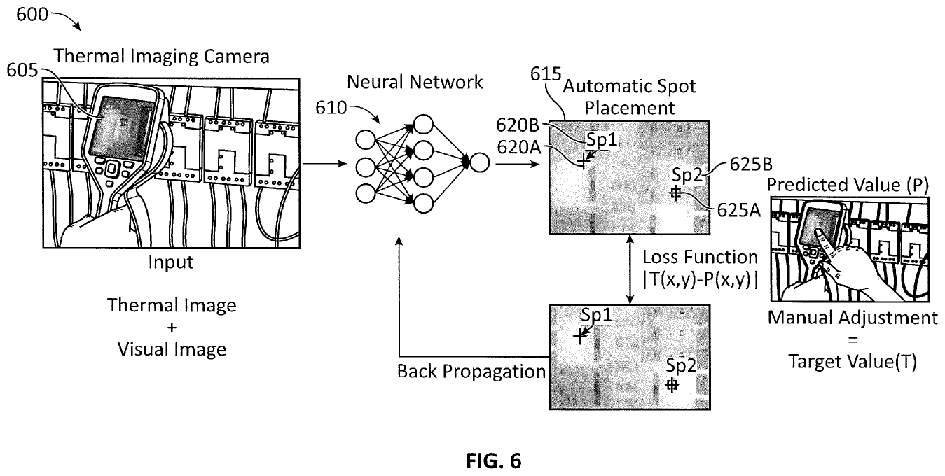

As an example, the image settings determined by the image analysis device 425 (e.g., using the trained machine learning model(s)) include temperature measurement locations (e.g., locations determined to be of interest) and measurement functions to be performed at these measurement locations. FIG. 6 illustrates a flow diagram 600 associated with automatic measurement alignment in accordance with one or more embodiments of the present disclosure. A thermal imaging camera 605 may include a thermal infrared sensor and a visible-light sensor. An operator may use the thermal imaging camera 605 to capture thermal image data of a scene with the thermal infrared sensor and visible-light image data of the scene with the visible-light sensor. The thermal imaging camera 605 may align the visible-light image data to the thermal image data and generate combined image data based on the thermal image and the visible-light image. The combined image data may be provided as an input to one or more neural networks, including a neural network 610 (e.g., CNN). The neural network 610 may be implemented by the thermal imaging camera 605 and/or a device communicatively coupled to the thermal imaging camera 605.

To facilitate analysis of the visible-light image data, the thermal image data, and/or the combined image data and/or facilitate determination of image settings, various data associated with a time of image capture of the thermal image data and the visible-light image data may be recorded and fed into the neural network(s). By way of non-limiting examples, the data may include a geoposition and/or an orientation of the thermal imaging camera 605 at the time of image capture, a distance to objects in the scene as represented in the combined image, an atmospheric temperature at the time of image capture, a relative humidity at the time of image capture, a temperature of one or more components of the thermal imaging camera 605 (e.g., within a camera housing) at the time of image capture, and/or other data. In this regard, the data may be indicative of conditions during operation of the thermal imaging camera 605 (e.g., also referred to as operating conditions of the thermal imaging camera 605). The data may be captured or determined using one or more sensors (e.g., temperature sensors, distance measurement device, geoposition device, humidity sensor). A sensor may be a part of the thermal imaging camera 605 (e.g., within a housing of the thermal imaging camera 605) or separate from and communicatively coupled to the thermal imaging camera 605. As such, in some cases, the thermal imaging camera 605 may connect to external sensors and equipment, for example over a network, to get/measure operating conditions.

The neural network 610 and/or other neural networks may output estimates/predictions for different image settings. In FIG. 6, the neural network 610 determines measurement locations in the combined image data at which to provide temperature data and determines that spot measurements are to be used to generate the temperature data. In this regard, the measurement locations and the measurement functions (e.g., spot measurements) associated with these measurement locations are image settings determined using the neural network 610. Indications 620A, 620B, 625A, and 625B of the image settings determined by the neural network 610 are provided in a processed combined image 615. The processed combined image 615 may be generated by the thermal imaging camera 605 using the combined image data, the image settings, the sensor data, and/or other data that may affect pixel values represented in the processed combined image 615. The indication 620A is a crosshair to identify a location of a measurement and the indication 620B is a label/annotation “Sp1” to indicate the measurement is a first spot measurement. Similarly, the indication 625A is a crosshair to identify a location of a measurement and the indication 625B is a label/annotation “Sp2” to indicate the measurement is a second spot measurement. In some cases, a blending of the thermal image and the visible-light image may be an image setting(s) determined by the thermal imaging camera 605.

The thermal imaging camera 605 provides a screen for displaying the processed combined image 615. In FIG. 6, the screen is a touchscreen that receives user input to move a location of the first spot measurement associated with the indications 620A and 620B and the second spot measurement associated with the indications 625A and 625B. In this regard, the user input is a manual adjustment of the spot placement automatically determined using the neural network 610. The indications 620A, 620B, 625A, and 625B may move responsive to the manual adjustment of the spot placements. With regard to spot measurements, the neural network 610 may be trained using a loss function provided by L(x, y)=|T(x, y)−P(x, y)|, where a predicted value P(x, y) is a spot measurement location determined (e.g., automatically/autonomously determined) by the neural network 610 and a target value T(x, y) is a spot measurement location set by the user via a manual adjustment of the spot measurement location determined by the neural network 610. It is noted that in some cases P(x, y) may be written as \hat{T}(x, y). This loss function may provide an absolute difference (e.g., measured in pixels) for spot measurement placements. In this regard, the neural network 610 may be trained using a loss value L₁ (x, y)=|T₁ (x, y)−P₁(x, y)| and a loss value L₂(x, y)=|T₂(x, y)−P₂(x, y)|, where T₁ (x, y) and P₁(x, y) are the target measurement location and the predicted measurement location, respectively, of the first measurement and T₂(x, y) and P₂(x, y) are the target measurement location and the predicted measurement location, respectively, of the second measurement. In an aspect, the loss function may be used to train the neural network 610 and/or other networks using back propagation and gradient descent. Although not shown in FIG. 6, the user may provide user input to change the first and/or second spot measurement to a different type of measurement (e.g., box-shaped measurement, line measurement, etc.), remove one or both of the first and second spot measurements, and/or add measurement locations and set associated measurement functions.

Furthermore, FIG. 6 illustrates an example in which the image settings are associated with automatic spot placement on an image. Other image settings and/or indications of the image settings may be provided to the user. In this regard, the user may be presented with some compilation of results associated with image settings determined in relation to an image associated with the image settings. The image settings and/or associated indications may be presented to the user directly on the image (e.g., as overlays) and/or via a separate interface. In some cases, the indication may be the image itself, which provides a visualization of a scene generated based on captured image data and image settings (e.g., emissivity, reflected temperatures, etc.). The user may be provided with an opportunity/interface to confirm or edit the image settings and/or associated data. Such an opportunity/interface may be provided directly on the camera and/or on a separate device. As one example, the camera may be used to capture images, determine image settings associated with the images, and receive user input. As another example, the camera may be used to capture images and these images extracted to a separate device for determining the image settings and/or receiving user input after the in-field image capture.

Appropriate loss functions may be defined for different image settings to train the neural network 610 and/or other networks based on any received user input (e.g., to improve user experience and/or to improve functionality of the thermal imaging camera 605). Various loss functions are provided below by way of non-limiting examples.

As one example (previously described above), a loss function associated with a measurement location may be provided by L(x, y)=\T(x, y)−\hat{T}(x, y)|, where T(x, y) is the target location and \hat{T}(x, y) is the location predicted using a machine learning model. As another example, a loss function L(x, y)=\T(x, y)−\hat{T}(x, y)| may also be defined where T(x, y) is a target temperature value of a pixel at a coordinate (x, y) and \hat{T}(x, y) is a predicted temperature value at the coordinate (x, y).

As another example, a loss function may be provided for an image setting containing (e.g., partially or exclusively) alphabetical characters, such as a note image setting or a text annotation image setting. In various embodiments, although such image settings are generally presented to and/or provided by the user as alphabetical characters, machine learning models generally take as input numerical representations/mappings of these alphabetical characters. As an example, the number 72 may represent the word “warm” and the number 24 may represent the word “too,” such that the sequence of numbers “24 72” would represent “too warm.” In one case, loss functions for image settings containing alphabetical characters may be considered to be and/or treated comparably to an automatic image captioning model based on one, or a combination, of CNN, recurrent neural network (RNN), and/or transformer models. In such a case, the loss function may be based on a categorical cross-entropy loss, sparse categorical cross-entropy loss, and/or other forms of cross-entropy loss. As one example, the loss function for image settings containing alphabetical characters may be a cross-entropy loss defined by:

$$L = - {\sum }_{i = 1}^{output size} {y}_{i} log ( {\hat{y}}_{i} )$$

where ŷᵢ is a predicted value of the image setting (e.g., determined using one or more machine learning models) and y; is a target value of the image setting (e.g., provided as user input to edit the predicted value ŷᵢ).

As an example, FIG. 7 illustrates a graphical user interface 700 for displaying (e.g., on a screen) image settings and receiving user input in accordance with one or more embodiments of the present disclosure. The graphical user interface 700 includes a panel 705 for displaying a selected image 710 and indications associated with one or more image settings; a panel 715 for displaying and selecting thumbnail versions of thermal images, visible-light images, and/or combined images that can be selected for display in the panel 705; a panel 720 for displaying one or more notes; a panel 725 for displaying measurement locations, measurement functions, and associated temperature data; a panel 730 for displaying and adjusting various parameters (e.g., emissivity, reflected temperature, distance, external optics temperature); a panel 735 for displaying and adjusting text annotations (e.g., fault type, recommended action, equipment type); a panel 740 for displaying and adjusting fusion mode settings (e.g., thermal only, visible-light only, blending, picture-in-picture); a panel 745 for displaying and adjusting measurement functions; a panel 750 for displaying and adjusting palette settings; a panel 755 for displaying and adjusting temperature alarms; and a panel 760 for displaying and adjusting gain settings. In some cases, content of the graphical user interface 700 may be organized differently depending on a size of the display device used by the user to display the graphical user interface 700. It is noted that, to conserve display space used, one or more of the panels may be collapsed partially or fully. As an example, the panel 730 may further include a reference temperature value as further referenced below.

As shown in FIG. 7, image settings determined by an imaging system may be provided by in the various panels. The operator may adjust the one or more of the image settings using the graphical user interface 700. As an example, with reference to the panel 720, one or more neural networks determined measurement locations Sp1, Sp2, Bx1, and Li1. The locations Sp1 and Sp2 are associated with spot measurements in the image 710. As indications associated with these spot measurement image settings, crosshairs and labels Sp1 and Sp2 are overlaid on the image 710. The location Bx1 is a box-shaped measurement region in the image 710, in which a maximum temperature, a minimum temperature, and an average temperature for the region are provided in the graphical user interface 700. As indications associated with this box-shaped measurement function image setting, a box and a label Bx1 are overlaid on the image 710. The location Li1 is a line-shaped measurement region in the image 710, in which a maximum temperature, a minimum temperature, and an average temperature for the region are provided in the graphical user interface 700. As indications associated with this line-shaped measurement function image setting, a line and a label Li1 are overlaid on the image 710. User input may adjust the locations Sp1, Sp2, Bx1, and/or Li1 and/or the measurement functions (e.g., box-shaped, line-shaped, spot) at these locations. In some cases, user input may remove one or more of the locations Sp1, Sp2, Bx1, and/or Li1 and/or add new measurement locations. As another example, the predicted recommended action of “Repair” may be manually adjusted to “Replace.”

A measurement function Dt1 is also provided in the panel 725. Dt1 is defined as a reference temperature (denoted as “Ref. temp”) subtracted by the temperature associated with Sp1. Although not explicitly shown, the reference temperature is 0° C. and, in some cases, may be provided in the panel 730. In some cases, the measurement function Dt1 is user-defined and is not an image setting predicted by a trained machine model learning. In other cases, the measurement function Dt1 may be an image setting predicted by a trained machine model learning. In some cases, the reference temperature is user-defined and is not an image setting predicted by a trained machine model learning. In other cases, the reference temperature may be an image setting predicted by a trained machine model learning. In some cases, rather than being a set value, the reference temperature may be a temperature at a reference location and/or of a reference target in the scene (e.g., an object having a known temperature). In some embodiments, whether a given term is strictly user-defined or an image setting to be automatically determined by a machine learning model and adjustable by the user may generally depend on user preference and/or application.

In some cases, an image setting may be set to one of multiple, discrete predetermined values. For example, the recommended action may be set to one of “Repair,” “Replace,” “Normal,” and “Further tests needed.” In some cases, the user may be provided with the opportunity add/suggest new values for any given image setting or otherwise provide values different from the predetermined values. In some cases, an image setting is not confined to predetermined values (e.g., the user may provide any target values).

In some cases, a weight (e.g., an importance) placed by the imaging system on a given data point (e.g., a given training dataset) may be based on a relevance to a machine learning model (e.g., the same data point may have a different weight applied for different neural networks) and/or the user themselves in relation to a particular application. As an example, the operator's level of training and/or area of expertise may be factored into the weight.

Utilization of predicted image settings and associated user input (or lack thereof) may allow for updated machine learning models that can be used to make better predictions. The updated machine learning models may be deployed in a single camera or multiple cameras (e.g., cameras of the same make and model or otherwise having nominally similar performance characteristics). In some embodiments, image settings determined by multiple cameras can be used together with user input corresponding to these image settings provided by the user and/or other users using the same camera(s) and/or different camera(s) may be used to train and update machine learning models.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. A method comprising:
receiving first image data associated with a scene;
determining, using a machine learning model, a first image setting based on the first image data;
providing an indication of the first image setting;
receiving first user input associated with the first image setting; and
determining, for use in training the machine learning model, a first training dataset based on the first user input and the first image setting.

2. The method of claim 1, further comprising:
adjusting the machine learning model based on the first training dataset to obtain an adjusted machine learning model;
receiving second image data associated with the scene; and
determining, using the adjusted machine learning model, a second image setting based on the second image data.

3. The method of claim 2, further comprising:
receiving second user input associated with the second image setting;
determining, for use in training the adjusted machine learning model, a second training dataset based on the second user input and the second image setting; and
adjusting the adjusted machine learning model based on the second training dataset to obtain a further adjusted machine learning model.

4. The method of claim 1, further comprising generating an image based on the first image setting, wherein the first image setting comprises an emissivity associated with an object in the scene, a reflected temperature associated with the object, a distance between the object and an image sensor device when the first image data is captured by the image sensor device, an atmospheric temperature, a temperature associated with optics of the image sensor device, and/or an atmospheric humidity.

5. The method of claim 1, wherein the indication comprises:
an image that represents the first image data and has one or more pixel values determined based in part on the first image setting,
a value associated with the first image setting, and/or
a location associated with the first image setting.

6. The method of claim 1, further comprising generating second image data based on the first image setting and the first image data, wherein:
the second image data comprises an image and temperature data associated with a portion of the image,
the first image setting comprises a first temperature measurement location indicative of the portion of the image, and
the first user input comprises an adjustment from the first temperature measurement location to a second temperature measurement location.

7. The method of claim 6, wherein the first training dataset is based on a difference between the first temperature measurement location and the second temperature measurement location.

8. The method of claim 6, further comprising displaying the image and the indication of the first image setting overlaid on the image, wherein the first image data comprises thermal infrared image data and visible-light image data, and wherein the generating the second image data comprises combining the thermal infrared image data and the visible-light image data to obtain the image.

9. The method of claim 1, further comprising:
determining, using the machine learning model, a second image setting based on the first image data; and
receiving second user input associated with the second image setting,
wherein the first training dataset is further based on the second image setting and the second user input, and wherein the second image setting comprises an emissivity associated with an object in the scene, a reflected temperature associated with the object, a distance between the object and an image sensor device when the first image data is captured by the image sensor device, an atmospheric temperature, a temperature associated with optics of the image sensor device, an atmospheric humidity, a measurement location, a measurement function, a palette to apply to the first image data, a fusion mode setting, a temperature alarm, a gain level, a fault severity assessment, a recommended action, an equipment type classification, or an annotation.

10. The method of claim 1, further comprising determining a weight associated with the first user input, wherein the first training dataset is further based on the weight.

11. The method of claim 1, wherein the machine learning model comprises a neural network-based machine learning model or a decision tree-based machine learning model.

12. An infrared imaging system comprising:
an infrared imager configured to capture first image data associated with a scene;
a logic device configured to determine, using a machine learning model, a first image setting based on the first image data; and
an output/feedback device configured to:
provide an indication of the first image setting;
receive first user input associated with the first image setting; and
determine, for use in training the machine learning model, a first training dataset based on the first user input and the first image setting.

13. The infrared imaging system of claim 12, wherein the logic device is further configured to:
adjust the machine learning model based on the first training dataset to obtain an adjusted machine learning model;
receive second image data associated with the scene; and
determine, using the adjusted machine learning model, a second image setting based on the second image data.

14. The infrared imaging system of claim 13, wherein:
the output/feedback device is further configured to:
receive second user input associated with the second image setting;
determine, for use in training the adjusted machine learning model, a second training dataset based on the second user input and the second image setting; and
the logic device is further configured to adjust the adjusted machine learning model based on the second training dataset to obtain a further adjusted machine learning model.

15. The infrared imaging system of claim 12, wherein the logic device is further configured to generate an image based on the first image setting, wherein the first image setting comprises an emissivity associated with an object in the scene, a reflected temperature associated with the object, a distance between the object and the infrared imager when the first image data is captured by the infrared imager, an atmospheric temperature, a temperature associated with optics of the infrared imager, and/or an atmospheric humidity.

16. The infrared imaging system of claim 12, wherein the logic device is further configured to generate second image data based on the first image setting and the first image data, wherein:
the second image data comprises an image and temperature data associated with a portion of the image,
the first image setting comprises a first temperature measurement location indicative of the portion of the image, and
the first user input comprises an adjustment from the first temperature measurement location to a second temperature measurement location.

17. The infrared imaging system of claim 16, wherein the first training dataset is based on a difference between the first temperature measurement location and the second temperature measurement location.

18. The infrared imaging system of claim 16, wherein the first image data comprises thermal infrared image data and visible-light image data, wherein the infrared imager comprises a thermal sensor device configured to capture the thermal infrared image data and a visible-light sensor device configured to capture the visible-light image data, wherein the logic device is further configured to generate the image by combining the thermal infrared image data and the visible-light image data, and wherein the output/feedback device is further configured to display the image and the indication of the first image setting overlaid on the image.

19. The infrared imaging system of claim 12, wherein the logic device is further configured to determining, using the machine learning model, a second image setting based on the first image data, wherein the output/feedback device is further configured to receive second user input associated with the second image setting, and wherein the first training dataset is further based on the second image setting and the second user input.

20. The infrared imaging system of claim 12, wherein the machine learning model comprises a neural network-based machine learning model or a decision tree-based machine learning model.
